(19) United States
(12) Patent Application Publication
(10) Pub. No.: US 2024/0296031 A1
(43) Pub. Date: Sep. 5, 2024

(54) MODIFYING OUTPUT CODE IN SOURCE CODE TO OUTPUT COMPRESSED OUTPUT STATEMENTS

(71) Applicant: INTERNATIONAL BUSINESS MACHINES CORPORATION, Armonk, NY (US)

(72) Inventors: Ronen SCHAFFER, Ra'anana (IL); Eran RAICHSTEIN, Yokneam Ilit (IL); Pratibha MOOGI, Bangalore (IN); Pranjal GUPTA, Bhilal (IN); Gerard Randolph VANLOO, White Plains, NY (US)

(21) Appl. No.: 18/177,540

(22) Filed: Mar. 2, 2023

(51) Int. Cl. G06F 8/41; G06F 8/36

(52) U.S. Cl. CPC G06F 8/4434; G06F 8/36

(57) ABSTRACT

Provided are a computer program product, system, and method for modifying output code in source code to output compressed output statements. A codebook indicates replacement codes associated with strings in output code in source code. The output code is to generate output statements. The strings of the output code are replaced with the replacement codes associated with the strings to produce modified source code. Multiple instances of a same string in the output code are replaced by an associated same replacement code in the codebook. The modified source code, having the replacement codes replacing the strings, is compiled to produce an executable application. The executable application during runtime produces compressed output statements comprising the replacement codes that replaced the associated strings.

### BACKGROUND OF THE INVENTION

### 1. Field of the Invention

The present invention relates to a computer program product, system, and method for modifying output code in source code to output compressed output statements.

### 2. Description of the Related Art

In network environments, a system, such as an edge device, may generate log files and messages, such as error and performance logs, and transmit to a central hub in a network. The system may have limited network bandwidth to transmit data and limited processor and memory resources. The log files may comprise very large amounts of data whose transmission over the network may consume substantial network bandwidth. The log files and messages may be compressed to conserve network bandwidth. However, the compression operations may tax processor and memory resources. Another approach is to extract templates from the logs and only send a template ID with variable values, which is more compact than the original log files and message. However, processing the log messages to extract and identify templates also requires processor and memory resources.

There is a need in the art to provide improved computer technology and techniques for reducing the size of generated log files and messages, and other data, without burdening processing and network bandwidth resources.

### SUMMARY

Provided are a computer program product, system, and method for modifying output code in source code to output compressed output statements. A codebook indicates replacement codes associated with strings in output code in source code. The output code is to generate output statements. The strings of the output code are replaced with the replacement codes associated with the strings to produce modified source code. Multiple instances of a same string in the output code are replaced by an associated same replacement code in the codebook. The modified source code, having the replacement codes replacing the strings, is compiled to produce an executable application. The executable application during runtime produces compressed output statements comprising the replacement codes that replaced the associated strings.

### BRIEF DESCRIPTION OF THE DRAWINGS

FIG. 1 illustrates an embodiment of a computing environment to modify output code in source code that when compiled produces an executable application that generates compressed output statements.

FIG. 2 illustrates an embodiment of an entry in a codebook associating a replacement code with a string in output code in the source code.

FIG. 3 illustrates an embodiment of a computing environment having a client system that runs the executable application to generate compressed output statements transmitted over a network to a system to decode and decompress.

FIG. 4 illustrates an embodiment of operations to modify the source code to replace strings in output code in the source code to produce compressed output statements.

FIG. 5 illustrates an embodiment of operations to decode compressed output statements to produce uncompressed output statements.

FIG. 6 illustrates an example of modifying source code file having output code to generate log output statements to produce modified source code to output compressed log statements.

FIG. 7 illustrates an example of modifying a source code having output code to generate output statements comprising requests to get and post metric information to produce modified source code to produce compressed get and post requests.

FIG. 8 illustrates a computing environment in which the components of FIGS. 1 and 3 may be implemented.

### DETAILED DESCRIPTION

Described embodiments provide improvements to computer technology to compress output statements from an application. Current techniques to compress output statements consume significant processor and memory resources to perform the compression operations. Described embodiments seek to avoid compressing output statements, such as log files, during runtime by modifying output code in the source code at build time by replacing strings in the output code with replacement codes added to a codebook. The modified source code is compiled to produce an executable application that executes the modified output code to produce compressed output statements that include replacement codes that provide a compact or compressed representation of the output statements. The described computer technology avoids having to utilize computational resources to compress the output statements at run time, such as log messages, or transmit the full output statements by modifying the source code to substitute strings in the output code with compression replacement codes so that the compiled executable application generates compressed output statements having the compression replacement codes in the codebook.

Described embodiments further provide a compression pre-compiler to automatically modify the source code to replace strings in output code that produces compressed output statements with compression replacement codes in a codebook. In this way, the described embodiments eliminate overhead from developers manually managing error codes by having the compression pre-compiler generate, manage, and use the replacement codes in a codebook.

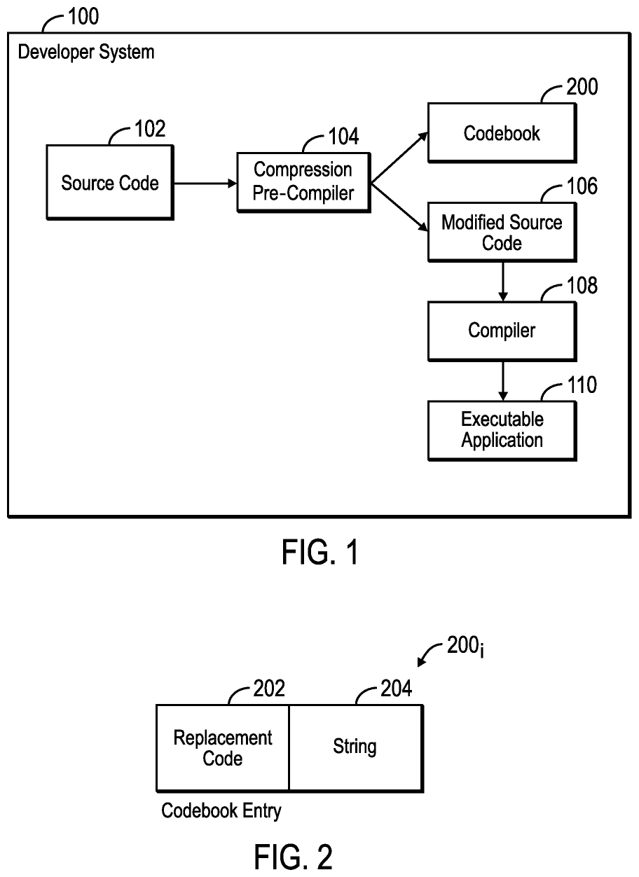

FIG. 1 illustrates an embodiment of a software developer system 100 a software developer uses to compile source code 102. The source code 102 may include output code to generate output statements. The output code may comprise message templates having substitution fields in which to substitute text, a format string for log statements having string substitution syntax and variables for substitution fields in the message, commands having literal text and parameters, including values for variables passed to the commands, requests and responses, e.g., Hypertext Transport Protocol (HTTP) GET and POST requests, etc. The developer may invoke a compression pre-compiler 104 to compress the output code by replacing strings in the output code with unique replacement codes to produce modified source code 106. The replaced strings may comprise elements of the output code, such as a literal statement, command names, parameters in commands, substitution syntax, substitution fields, constant text for variables, etc.

The compression pre-compiler 104 generates a codebook 200 (FIG. 2) having entries 200ᵢ of unique replacement codes 202 and the associated strings 204 in the output code replaced by the replacement codes 202. The modified source code 106 is sent to a compiler 108 to compile and produce an executable application 110 that generates the compressed output statements with the replacement codes 202. The replacement codes 202 that replace associated strings 204 in the output code have fewer characters than the replaced strings 204.

With the embodiment of FIG. 1, the compression pre-compiler 104 modifies output code, such as output commands that generate output statements, to produce compressed output statements having the compressed replacement codes. Transmission of the compressed output statements over a network reduces network bandwidth due to the compression of the content.

The compression pre-compiler 104 may process different source code files 102 to produce different codebooks 200 to use to decompress output statements from different executable applications 110.

FIG. 2 illustrates an embodiment of an instance of a codebook entry 200ᵢ in a codebook 200 including a unique replacement code 202 generated to replace a string 204 in the output code. In this way, the entry 200ᵢ associates a unique replacement code 202 with the specific string of the output code 204 replaced in the modified source code 106. There may be multiple codebooks 200 generated by the compression pre-compiler 104 when processing different source code files.

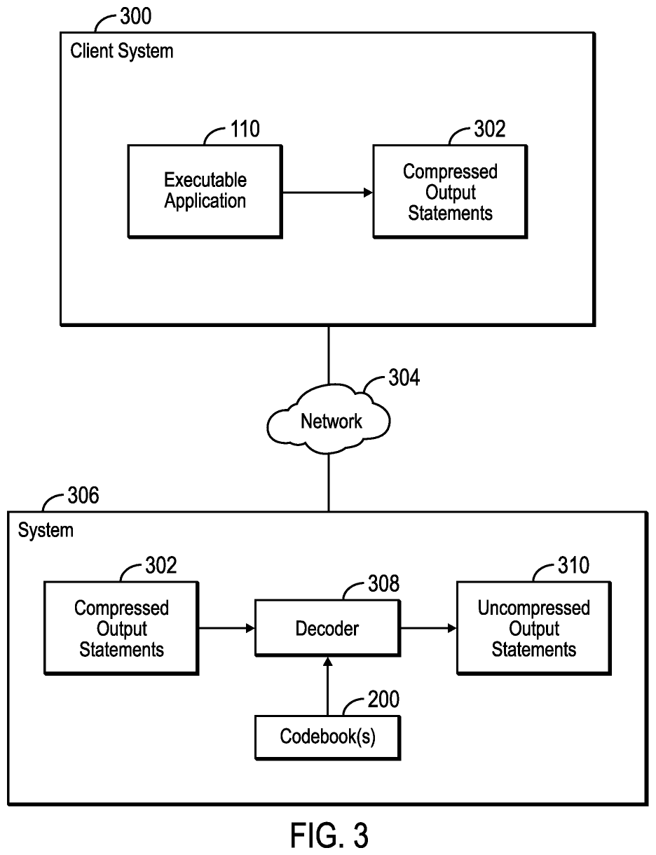

FIG. 3 illustrates an environment in which the executable application 110 and codebook 200 may be deployed. A client system 300, such as an edge computing device which may have limited network bandwidth and computational resources, runs the executable application 110, that comprises the replacement codes 202, to produce compressed output statements 302. Strings in the compressed output statements are replaced with replacement codes 202 in a codebook 200 generated from the source code 102 for the executable application 110 to produce uncompressed output statements. The client system 300 transmits the compressed output statements 302 over a network 304 to a system 306, such as a server or central network hub receiving output statements from different client systems 300 running the executable application 110, or other executable applications whose output code is replaced with replacement codes from different codebooks 200 for the applications 110.

The system 306 includes a decoder 308 that receives the compressed output statements 302 and uses a codebook 200 for the executable application 110 to replace replacement codes 202, from the codebook 200, identified in the compressed output statements 302 with the strings 204 associated with the replacement codes 202 in the codebook 200 to produce uncompressed output statements 310. In certain implementations, the decoder 308 may have access to multiple codebooks 200 of replacement codes 202 generated for different source code files 102 and executable applications 110. In such case, the decoder 308 would select a codebook 200 to use generated specifically for the executable application 110 sending the compressed output statements 302 to allow the decoder 308 to decompress compressed output statements 302 from different executable applications 110. The client system 300 may identify the executable application used to generate the compressed output statements 302 when transmitting over the network 304.

The network 304 may comprise a network such as a Storage Area Network (SAN), Local Area Network (LAN), Intranet, the Internet, Wide Area Network (WAN), peer-to-peer network, wireless network, arbitrated loop network, etc.

The arrows shown in FIGS. 1 and 3 between the components and objects represent a data flow between the components.

Generally, program modules, such as the program components 104, 106, 110, 200, 308 may comprise routines, programs, objects, components, logic, data structures, and so on that perform particular tasks or implement particular abstract data types. The program components and hardware devices of the computing devices 100 (FIG. 1) and 300, 306 (FIG. 3) may be implemented in one or more computer systems, where if they are implemented in multiple computer systems, then the computer systems may communicate over a network.

The program components 104, 106, 110, 200, 308 may be accessed by a processor from memory to execute. Alternatively, some or all of the program components 104, 106, 110, 200, 308 may be implemented in separate hardware devices, such as Application Specific Integrated Circuit (ASIC) hardware devices.

The functions described as performed by the program 104, 106, 110, 200, 308 may be implemented as program code in fewer program modules than shown or implemented as program code throughout a greater number of program modules than shown.

In the embodiment of FIG. 3, the decoder 308 is in a system 306 separate from the client system 300 including the executable application 110 generating the compressed output statements 302 and transmitting over the network 304. In a further embodiment, the decoder 308 may be on the same system as the executable application 110 such that the application 110 transfers the output statements to the decoder 308, executing in the same system, through shared memory or application program interfaces (APIs).

The client system 300 may comprise an edge system having limited computational resources and bandwidth to connect over the network 304, and the system may comprise a server or workstation, or other type of computing device for receiving output statements from multiple edge and other systems.

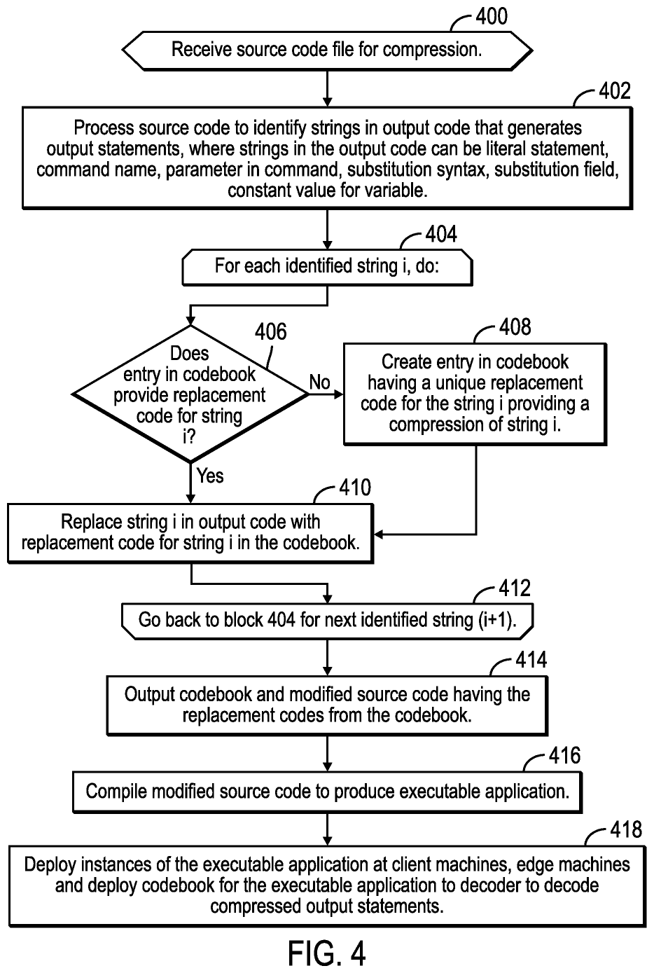

FIG. 4 illustrates an embodiment of operations performed in the developer system 100 by the compression pre-compiler 104 and the compiler 108 to modify the source code 102 and compile modified source code 106 to generate compressed output statements that may be transmitted over the network 304. Upon receiving (at block 400) a source code file 102 to modify, the compression pre-compiler 104 processes (at block 402) source code 102 to identify strings in output code that generates output statements. The identified strings in the output code can be literal statements, command names, parameters in commands, substitution syntax, substitution fields, constant values for variables, and other elements and combinations thereof in the output code. A loop of operations at blocks 404 through 412 are performed for each string i identified in the output code. If (at block 406) there is no entry 200ᵢ in the codebook 200 for string i, then an entry 200ᵢ is created (at block 408) in the codebook 200 having a unique replacement code 202 for the string i providing a compression or compact representation of string i. If string i cannot be compacted/compressed, then no replacement may be made of string i. Thus, the replacement codes 202 comprise compression codes. After creating an entry 200ᵢ for string i (at block 408) or if there is already an entry 200ᵢ in the codebook for string i (from the yes branch of block 406), string i is replaced (at block 410) in the output code with the replacement code 202 for string i 204 in the codebook to produce the modified source code 106.

After processing all identified strings i, the compression pre-compiler 104 outputs (at block 414) the codebook 200 and the modified source code 106 having the codebook replacement codes replacing strings of output code. The compiler 108 compiles (at block 416) the modified source code 106 to produce the executable application 110. Instances of the executable application 110 may be deployed (at block 418) at client systems 300, such as edge machines, and the codebook 200 is deployed to the decoder 308 to use to decode compressed output statements 302. The uncompressed output statements 310 may then be made available for visualization, query and retrieval processes.

With the embodiment of FIG. 4, strings in output code of the source code are replaced by compression replacement codes to provide compression/compaction of those strings in compressed output statements produced by an application 110 compiled from the source code 102. This embodiment performs the compression during build-time in the source code 102 before runtime operations, such that the source code 102 is compiled with the replacement codes so that subsequent output statements also include the compressed replacement codes. In this way, output statements from an application are compressed without having to perform actual compression on the output statements during runtime because the compression related operations are performed by modifying during build-time the output code in the source code that generates the compressed output statements.

Further, with the described embodiments, the codebook 200 is populated during software static code analysis time, which can be integrated with the build phase of the executable application 110 software development and release.

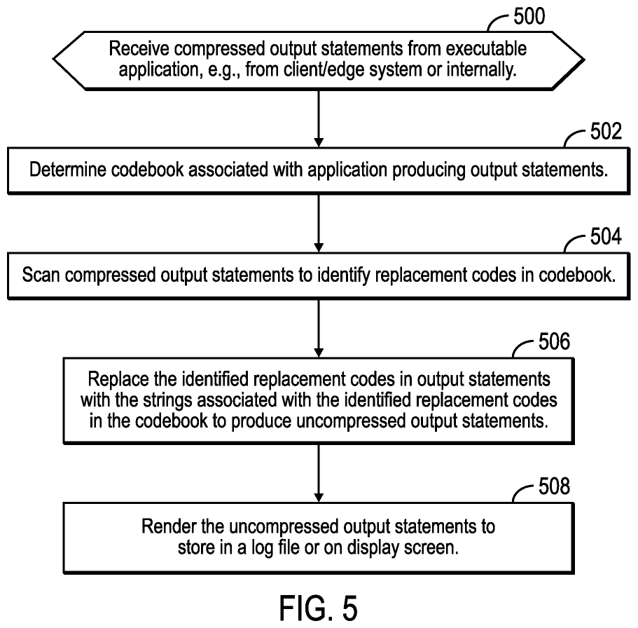

FIG. 5 illustrates an embodiment of operations performed by the decoder 308 to decode compressed output statements 302 to produce uncompressed output statements 310 that will be comprehensible to users. Upon receiving (at block 500) compressed output statements 302 from a client system 300 over a network 304, or from a local executable application 110 in the same system, the decoder 308 determines (at block 502) a codebook 200 associated with application 110 producing the compressed output statements 302 if there are multiple codebooks 200 to use for decoding. The decoder 308 scans (at block 504) the compressed output statements 302 to identify replacement codes 202 in the codebook 200. The identified replacement codes in the output statements are replaced (at block 506) with the strings 204 associated with the identified replacement codes 202 in the codebook 200 to produce uncompressed output statements 310. The uncompressed output statements 310 may then be rendered (at block 508) on a display screen or stored in a log file.

With the embodiment of FIG. 5, a decoder 308 decodes the replacement codes in the output statements with the associated strings 204 in the codebook 200 to allow decoding of the statements.

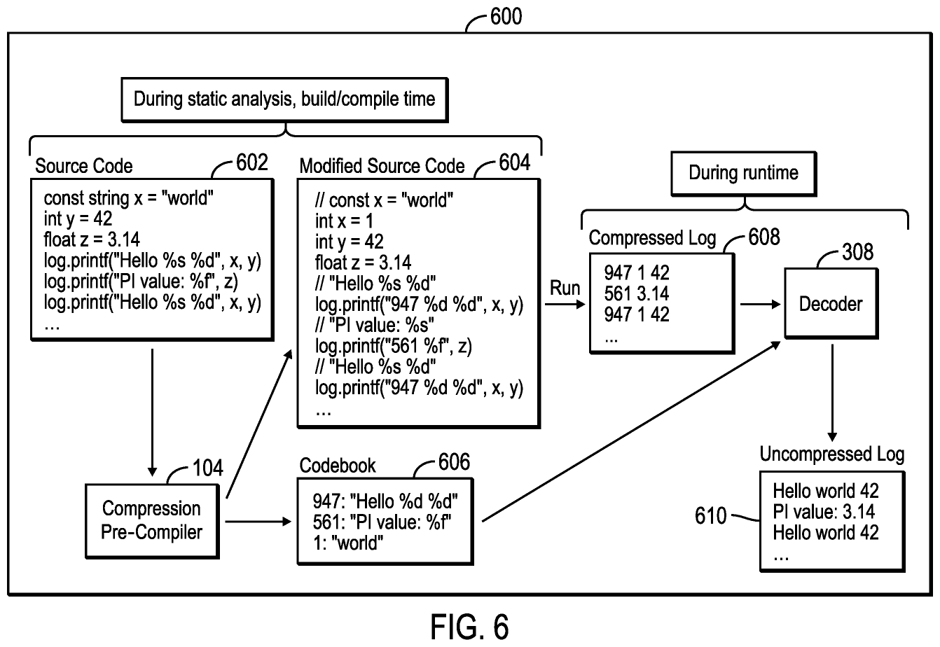

FIG. 6 illustrates an implementation 600 where the source code 602 has log commands, comprising the output code, to output literal statements and variables, including a variable x defined as a constant string. The compression pre-compiler 104, during build/compile time, replaces these string elements of the output code, parameters of the “log.printf” commands, with replacement codes in the modified source code 604 resulting in modified source code 604. For instance, the literal statements “hello”, “PI value:”, and constant for x of “world” in the output code are replaced with replacement codes 947, 561, and 1, respectively, as shown in the codebook 606. The modified source code 604 is compiled and run to produce the compressed log 608 comprising the compressed output statements including the replacement codes 947, 561, and 1 substituted for the associated strings in the codebook 606. The decoder 308 may then use the codebook 606 to replace the replacement codes 947, 561, and 1 with the associated strings in the codebook to produce the uncompressed log 610.

The decoder 308 may also substitute variables with the variable values. For example, given the compressed output statement “561 3.14”, the decoder 308 will first retrieve the template that corresponds to the replacement code 561 of “PI value: %f” and then substitute the variable “%f” with the variable value 3.14 to produce uncompressed output statement “PI value: 3.14”. Further, the decoder 308 may also substitute variables anywhere in the output code template, including in the middle of code. Below is an example of the progression when the variables are located throughout the output code template:
log command “log.printf (“User ID %d logged in from address %s”, userId, addr)”;
the output code, or first parameter of the log command, is “User ID %d logged in from address %s”;
the codebook may have a replacement code “789” for the first parameter string “User ID %d logged in from address %s”;
the compressed output statement comprises “789 1234 “77.177.77.77”, where “789” is the replacement code, “1234” is the value for variable “%d”, and “77.177.77.77” is the value for variable “%s”; and
the resulting uncompressed output statement is ““User ID 1234 logged in from address 77.177.77.77”.

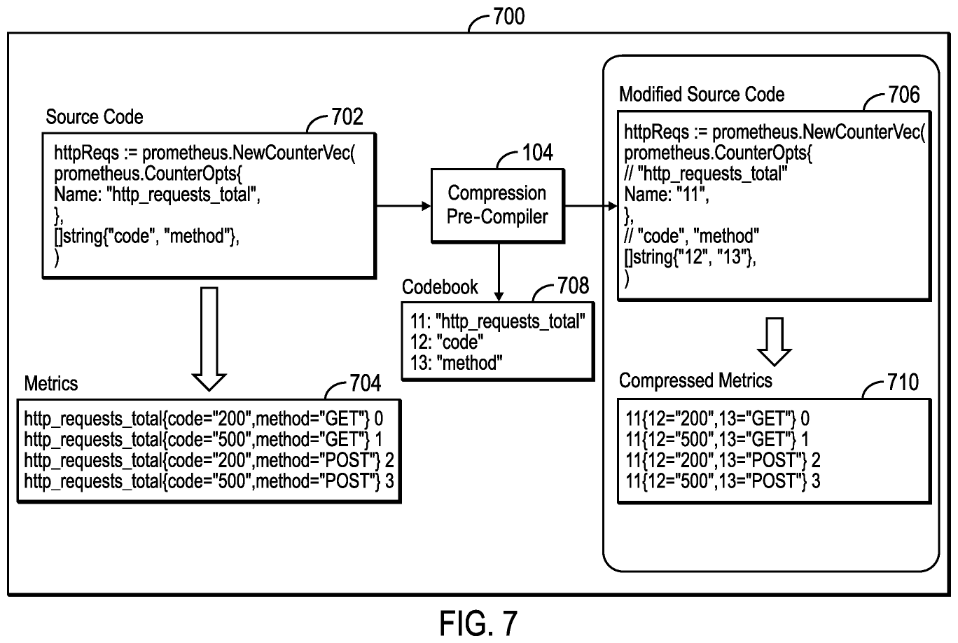

FIG. 7 illustrates an implementation 700 where the source code 702 has HTTP requests as the output code which produces metrics or HTTP statements 704 transmitted to another system to execute. The output HTTP statements 704 comprise the uncompressed statements that would be produced from the compiled uncompressed code file 702. The strings of the output code, HTTP requests, that are replaced comprise the HTTP request name and parameter names, such as “code” and “method”. The uncompressed output statements 704 include the HTTP name, parameters code and method uncompressed in the HTTP requests. The compression pre-compiler 104, during build/compile time, replaces these HTTP string elements of the output code with replacement codes in the compressed source code 706. For instance, the HTTP name “http_requests_total” and parameter names “code” and “method” are replaced with replacement codes 11, 12, and 13, respectively, as shown in the codebook 708. The compressed source code 706 is compiled and run to produce the compressed metrics 710 comprising the compressed output statements including the replacement codes 11, 12, and 13 substituted for the associated strings in the codebook 708. The decoder 308 may then use the codebook 708 to replace the replacement codes 11, 12, and 13 in the compressed metrics 710 with the associated strings in the codebook 708 to produce the uncompressed metrics, as shown in metrics 704.

In the above embodiments, string names, such as command names, parameter names, and constants, are replaced by the replacement codes in the codebook, but values provided for the parameters in the command arguments are not replaced.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, including compressing output code in source code to provide modified source code, generating a codebook to deploy to a decoder to decode compressed output statements from an executable application compiled from the modified source code to produce uncompressed output statements.

In addition to block 801, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 801, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

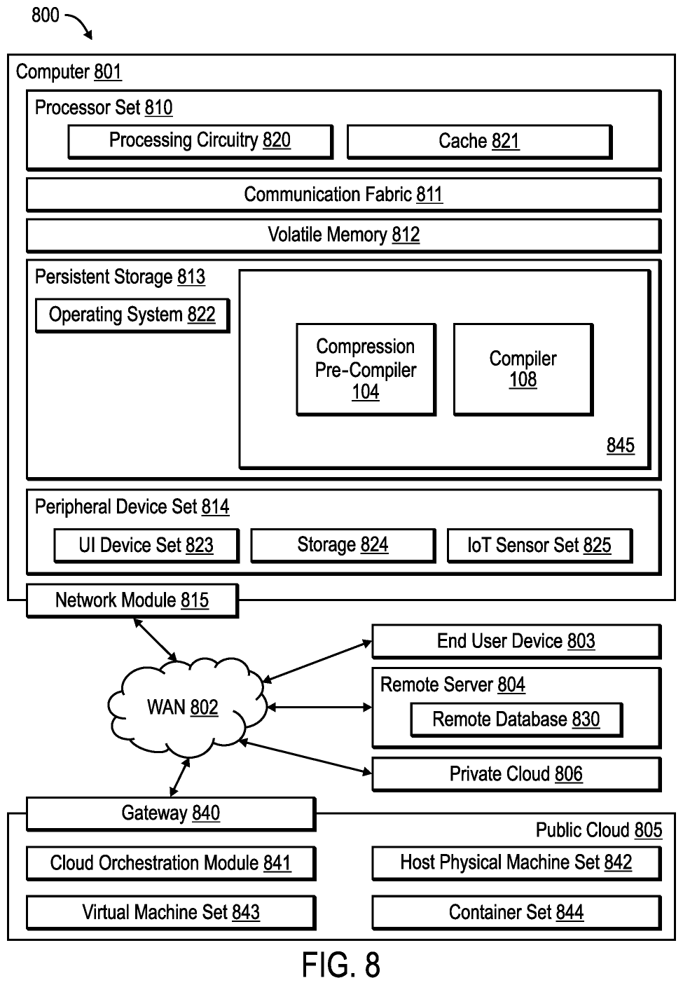

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a string of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 845 in the persistent storage 813 typically includes at least some of the computer code involved in performing the inventive methods, including the compression pre-compiler 104 and compiler 108.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on. The EUD 803 may implement the executable application 110 to produce the compressed output statements 302 as shown in FIG. 3.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804. The remote server 804 may implement components in system 306 (FIG. 3) including the decoder 308 and codebook 200 to decode the compressed output statements 302 to produce uncompressed output statements 310.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for processing source code to reduce size of output statements, the computer program product comprising a computer readable storage medium having computer readable program code embodied therein that is executable to perform operations, the operations comprising:
indicating in a codebook replacement codes associated with strings in output code in source code, wherein the output code is to generate output statements;
replacing the strings of the output code with the replacement codes associated with the strings to produce modified source code, wherein multiple instances of a same string in the output code are replaced by an associated same replacement code in the codebook; and
compiling the modified source code, having the replacement codes replacing the strings, to produce an executable application, wherein the executable application during runtime produces compressed output statements comprising the replacement codes that replaced the associated strings.

2. The computer program product of claim 1, wherein the operations further comprise:
providing a decoder that when executed performs operations, the operations comprising:
receiving the compressed output statements produced by the executable application during the runtime;
identifying replacement codes from the codebook in the received compressed output statements;
replacing the identified replacement codes with the strings associated with the identified replacement codes in the codebook; and
outputting uncompressed output statements comprising the strings replacing the identified replacement codes in the compressed output statements.

3. The computer program product of claim 1, wherein the executable application is implemented in a first system in a network and wherein a decoder is implemented in a second system in the network, wherein the executable application runs on the first system to produce the compressed output statements with the replacement codes to transmit over the network to the second system, wherein the decoder running in the second system replaces the replacement codes in the compressed output statements with the strings associated with the replacement codes in the codebook.

4. The computer program product of claim 1, wherein the source code comprises first source code, the codebook comprises a first codebook, the modified source code comprises first modified source code, and the executable application comprises a first executable application, wherein the operations further comprise:
processing second source code to replace strings in output code of the second source code with replacement codes in a second codebook to produce second modified source code to compile to produce a second executable application, wherein the first source code has different output code than the second source code, and wherein the first codebook and the second codebook have different replacement codes and associated strings.

5. The computer program product of claim 4, wherein the operations further comprise:
replacing first replacement codes, in a first codebook, identified in first compressed output statements from the first executable application with first strings associated with the first replacement codes in the first codebook; and
replacing second replacement codes in a second codebook identified in second compressed output statements from the second executable application with second strings associated with the second replacement codes in the second codebook.

6. The computer program product of claim 1, wherein the strings in the output code replaced with the replacement codes are members of a set of strings consisting of: a literal statement; a command; an argument in a command; substitution syntax; a substitution field to replace the substitution syntax; and a constant value for a variable in a substitution field.

7. The computer program product of claim 1, wherein the output code in the source code is to produce logging information on a system in which the executable application runs.

8. The computer program product of claim 1, wherein the output code in the source code comprises a command name including parameter names set to values in arguments of the command name, wherein the operations further comprise:
indicating replacement codes in the codebook associated with the command name and the parameter names; and
replacing the command name and the parameter names in the output code with the replacement codes associated with the command name and the parameter names.

9. The computer program product of claim 1, wherein the output code in the source code comprises a variable defined in the source code be a constant string, wherein the operations further comprise:
indicating a replacement code in the codebook associated with constant string; and
replacing the variable in the output code with the replacement code associated with the constant string.

10. A system for processing source code to reduce size of output statements, comprising:
a processor; and
a computer readable storage medium having computer readable program code embodied therein that when executed by the processor performs operations, the operations comprising:
indicating in a codebook replacement codes associated with strings in output code in source code, wherein the output code is to generate output statements;
replacing the strings of the output code with the replacement codes associated with the strings to produce modified source code, wherein multiple instances of a same string in the output code are replaced by an associated same replacement code in the codebook; and
compiling the modified source code, having the replacement codes replacing the strings, to produce an executable application, wherein the executable application during runtime produces compressed output statements comprising the replacement codes that replaced the associated strings.

11. The system of claim 10, wherein the operations further comprise:
providing a decoder that when executed performs operations, the operations comprising:
receiving the compressed output statements produced by the executable application during the runtime;
identifying replacement codes from the codebook in the received compressed output statements;
replacing the identified replacement codes with the strings associated with the identified replacement codes in the codebook; and
outputting uncompressed output statements comprising the strings replacing the identified replacement codes in the compressed output statements.

12. The system of claim 10, wherein the source code comprises first source code, the codebook comprises a first codebook, the modified source code comprises first modified source code, and the executable application comprises a first executable application, wherein the operations further comprise:
processing second source code to replace strings in output code of the second source code with replacement codes in a second codebook to produce second modified source code to compile to produce a second executable application, wherein the first source code has different output code than the second source code, and wherein the first codebook and the second codebook have different replacement codes and associated strings.

13. The system of claim 10, wherein the strings in the output code replaced with the replacement codes are members of a set of strings consisting of: a literal statement; a command; an argument in a command; substitution syntax; a substitution field to replace the substitution syntax; and a constant value for a variable in a substitution field.

14. The system of claim 10, wherein the output code in the source code comprises a command name including parameter names set to values in arguments of the command name, wherein the operations further comprise:
indicating replacement codes in the codebook associated with the command name and the parameter names; and
replacing the command name and the parameter names in the output code with the replacement codes associated with the command name and the parameter names.

15. The system of claim 10, wherein the output code in the source code comprises a variable defined in the source code be a constant string, wherein the operations further comprise:
indicating a replacement code in the codebook associated with constant string; and
replacing the variable in the output code with the replacement code associated with the constant string.

16. A method for processing source code to reduce size of output statements, comprising:
indicating in a codebook replacement codes associated with strings in output code in source code, wherein the output code is to generate output statements;
replacing the strings of the output code with the replacement codes associated with the strings to produce modified source code, wherein multiple instances of a same string in the output code are replaced by an associated same replacement code in the codebook; and
compiling the modified source code, having the replacement codes replacing the strings, to produce an executable application, wherein the executable application during runtime produces compressed output statements comprising the replacement codes that replaced the associated strings.

17. The method of claim 16, further comprising:
providing a decoder that when executed performs operations, the operations comprising:
receiving the compressed output statements produced by the executable application during the runtime;
identifying replacement codes from the codebook in the received compressed output statements;
replacing the identified replacement codes with the strings associated with the identified replacement codes in the codebook; and
outputting uncompressed output statements comprising the strings replacing the identified replacement codes in the compressed output statements.

18. The method of claim 16, wherein the source code comprises first source code, the codebook comprises a first codebook, the modified source code comprises first modified source code, and the executable application comprises a first executable application, wherein the operations further comprise:
processing second source code to replace strings in output code of the second source code with replacement codes in a second codebook to produce second modified source code to compile to produce a second executable application, wherein the first source code has different output code than the second source code, and wherein the first codebook and the second codebook have different replacement codes and associated strings.

19. The method of claim 16, wherein the output code in the source code comprises a command name including parameter names set to values in arguments of the command name, wherein the operations further comprise:
indicating replacement codes in the codebook associated with the command name and the parameter names; and
replacing the command name and the parameter names in the output code with the replacement codes associated with the command name and the parameter names.

20. The method of claim 16, wherein the output code in the source code comprises a variable defined in the source code be a constant string, wherein the operations further comprise:
indicating a replacement code in the codebook associated with constant string; and
replacing the variable in the output code with the replacement code associated with the constant string.
